(19) United States
(12) Patent Application Publication
(10) Pub. No.: US 2025/0369462 A1
(43) Pub. Date: Dec. 4, 2025

(54) CLAMP WITH STRONGER CLOSING HOOK DESIGN

(71) Applicant: Oetiker Schweiz AG, Horgen (CH)

(72) Inventors: Steffen Richter, Horgen (CH); Christoph SCHNEEBERGER, Horgen (CH); Maxim HAMMERSCHMIDT, Horgen (CH); Bianca GRIMALDI, Horgen (CH)

(73) Assignee: Oetiker Schweiz AG, Horgen (CH)

(21) Appl. No.: 18/872,880

(22) PCT Filed: Jun. 1, 2023
(86) PCT No.: PCT/EP2023/064725

§ 371 Date: Dec. 9, 2024

(30) Foreign Application Priority Data
Jun. 10, 2022 (DE) 102022114748.7

(51) Int. Cl. F16B 2/08; F16L 3/137

(52) U.S. Cl. CPC F16B 2/08; F16L 3/137

(57) ABSTRACT

A clamp (10) made of a clamping band (1) having first and second circumferential end portions (2, 3) which overlap one another in a closed condition of the clamp (10). The clamp (10) has a connecting hook (20) protruding radially outwards at the first end portion (2), a first tensioning hook (30) protruding radially outwards at the first end portion (2), and a second tensioning hook (40) protruding radially outwards at the second end portion (3) and having an aperture (42) for receiving an edge portion (21) of the connecting hook (20) in the closed condition of the clamp (10). At least one of the connecting hook (20) and the first and tensioning hooks (30, 40) has a cut-out window (22, 43) in which a two-dimensional area of material is removed from the clamping band (1), and the cut-out window (22, 43) preferably has rounded, arc-shaped portions (24) in regions laterally adjacent to the edge portion (21) of the connecting hook (20) and/or a tooth-like projection (31, 41) of the first or second tensioning hook (30, 40).

The present invention relates to a clamp made from a flat metal band or strip formed into a loop to be fastened around an object of substantially circular cross-section such as a hose, pipe or boot. In particular, the present invention relates to a so-called “low profile clamps”, i.e., clamps having only small radial outward projecting parts leading to a relatively small overall radial clamp profile. Further, the present invention relates particularly to so-called stepless clamps, i.e., clamps having in their closed condition almost no uneven portions or steps at the inner surface.

US 2009/0313792 A1 discloses a conventional clamp having a connecting hook (fastening stud) projecting radially outwards in the vicinity of the first end of the strip and a tensioning hook (fastening ear) projecting radially outwards in the vicinity of the second end of the strip and provided with an aperture into which a free end edge portion of the connecting hook can be inserted for the purposes of fastening and of tightening the clamp while the fastening ear fits over a foot portion of the connecting hook.

WO 2018/082819 A1 gives another example of such a conventional clamp having closing hooks in form of a connecting hook and two tensioning hooks for tightening the clamp around the object to be fastened by a tightening tool such as pliers.

A disadvantage encountered with those conventional clamps resides in the insufficient load retaining characteristics of its closing hooks. When the closed clamp undergoes high radial expansion forces, the edge portion of the connecting and/or tensioning hooks tends to get deformed and/or cracks in the band material arise at the lateral sides of the edge portion. Furthermore, cracks may already arise at the cutting and embossing steps during the hook manufacturing process for conventional clamps.

US 2017/0227030 A1 and WO 2006/111181 A1 describe conventional clamps whose hooks are adjacent to punched-out band openings. However, the openings are provided without positive effect on the load retaining characteristic of the hooks.

An object of the present invention is to improve the strength and rigidity of the connecting and/or tensioning hooks without detriment to cost and useability of the clamp.

This object is achieved by the clamp defined in claim 1. The other claims relate to preferred embodiments and a corresponding manufacturing method.

According to the present invention, at least one of the connecting hook and the first and second tensioning hooks is strengthened by a cut-out window formed by removing from the flat clamping band a two-dimensional area of band material laterally adjacent to the edge portion of the connecting hook and/or laterally adjacent to a tooth-like projection of at least one of the tensioning hooks. When the closed clamp undergoes high radial expansion forces, the shape of the cut-out window distributes the material deformation stress acting on the band regions laterally adjacent to the edge portion and/or to the tooth-like projection more evenly and thereby avoids cracking even under high radial stress.

The hook strengthening may be enhanced when at least parts of the rim of the cut-out window, preferably at least 50% of the entire window rim, are raised radially outwards. For example, at least three sides of the window rim are raised so as to form a radial protrusion. This allows for distributing the material deformation stress acting on the band regions laterally adjacent to the edge portion and/or to the tooth-like projection in three dimensions, i.e., not in only axially but also circumferentially along the radial extension of the raised band material. Thereby, the hooks are strengthened and get more robust against deformation stress.

In a preferred example, the second tensioning hook is strengthened by the claimed cut-out window. According to this example, all of the window rim except from the sides or portions of the window which are opposite to the tooth-like projection of the second tensioning hook are raised radially outwards to form a canopy-like or shell-shaped protrusion with the tooth-like projection formed as a peak at the radial tip end.

In another preferred example, the connecting hook is strengthened by the claimed cut-out window. According to this example, the entire rim of the cut-out window is raised radially outwards to form a collar-like protrusion with the edge portion of the connecting hook formed as a peak at the radial tip end.

The strengthening of the hooks by the cut-out window works particularly well, when the window has rounded portions in the regions laterally adjacent to the edge portion and/or to the tooth-like projection, particularly two rounded portions having semi-circular shape at either lateral side next to the edge portion and/or to the tooth-like projection. The semi-circular or arc-shaped portions have shown an optimised load distribution profile.

The window may preferably further have a base portion which may have a rounded rectangular shape. The base portion allows smooth deformation of the material at the window rim during the manufacturing process of the clamp. Thereby, the side walls of the edge portion and/or to the tooth-like projection can be formed to rise in a smooth slope and a rounded geometry with low cracking tendency even under high radial stress. The base portion and the arc-shaped corner portions of the window are arranged such that they surround the edge portion and/or to the tooth-like projection from both lateral sides in the width direction and from one side in the circumferential direction of the clamping band. Finite Element Analysis (FEA) has rendered a particularly good load distribution for this geometry of the connecting hook (also referred to as “load retaining hook”) and/or the tensioning hooks.

A particularly important embodiment of the invention (which can also be claimed independently from any window in the connecting hook and/or the tensioning hooks-see last part of the present description) calls for positioning the connecting hook and the first tensioning hook circumferentially adjacent to each other on the first end portion so that a contact region between them has a curved shape, preferably a curved line shape. Unlike the connecting hook and the first tensioning hook, the contact region does not protrude radially from the level of the flat clamping band. The contact region has a curved shape, i.e., it extends generally in the width direction but not in a straight line perpendicular to the longitudinal direction of the band. This helps to avoid kinking or buckling of the band material in the region between the connecting hook and the first tensioning hook when the clamp is closed by a tightening tool, e.g., by pliers whose jaws act on the first and second tensioning hooks.

Radially protruding side rails formed at both lateral sides of the band region in which the connecting hook and the first tensioning hook are formed help to further stiffen the band material and avoid buckling.

Embodiments of the invention will now be described below in greater detail with reference to the drawings, in which:

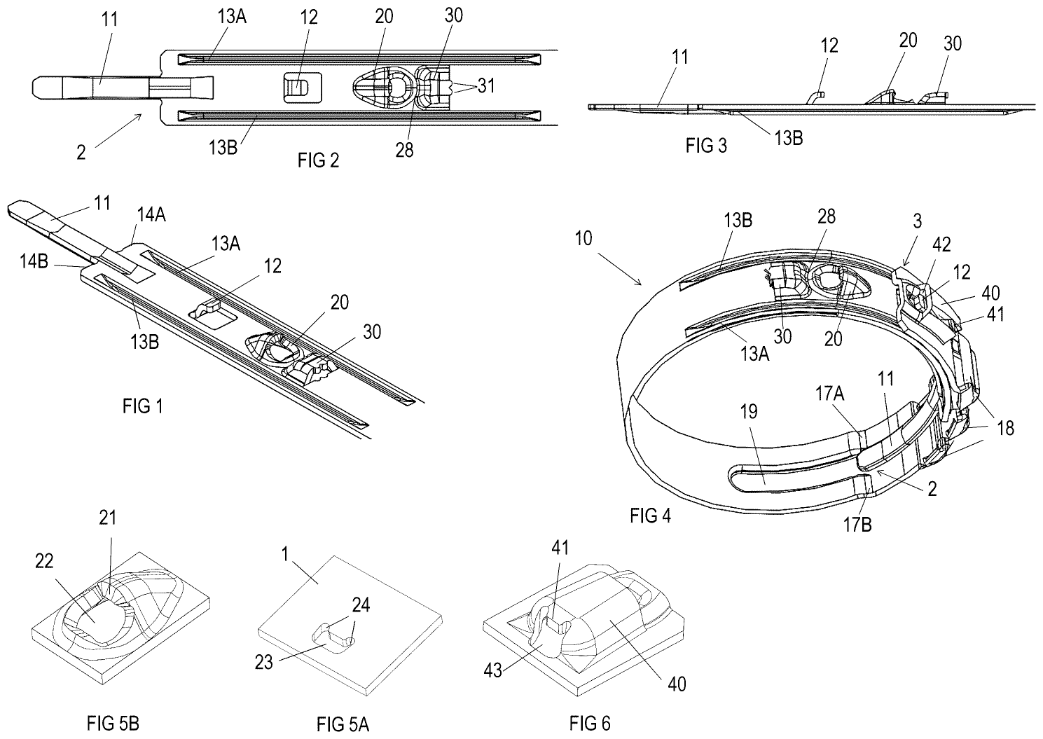

FIG. 1 is a perspective view of the first end portion of the clamp according to a first embodiment of the present invention in a flat (unrounded) state;

FIG. 2 is a top view of the first end portion shown in FIG. 1;

FIG. 3 is a side view of the first end portion shown in FIG. 1 taken along the longitudinal extension of the clamping band;

FIG. 4 is a perspective view of the clamp according to the embodiment of the present invention in a rounded and preassembled state;

FIG. 5A is a partial view of a part of flat band material in which the cut-out window is removed before forming radial protrusions;

FIG. 5B is a partial view of the same part of flat band material as in FIG. 5A after forming the connecting hook; and

FIG. 6 is a perspective view of the second tensioning hook according to a second embodiment of the present invention.

In the present specification, the terms “radial”, “axial” and “circumferential” refer to an overall geometrical form of the clamp which, in its closed state, is generally a ring having a certain radius and circumference. The clamp is designed for embracing a pipe, hose or boot which extends substantially in the axial direction.

FIGS. 1-3 show the first circumferential end portion 2 of the clamp 10 in a flat (unrounded) state. FIG. 4 shows the complete clamp in a rounded state and hooked in a preassembling position in which the clamp radius is larger than in the final closed state.

The clamp 10 is made from a flat metal band or strip 1 by various cutting and deforming or embossing steps which are generally known in the art. The tip end of the first circumferential end portion 2 has a reduced width and forms a tongue portion 11 adapted to be received in a tongue channel 19 at the inside of the second end portion 3 of the band 1 (see FIG. 4). At the end of the tongue channel 19 there are stepped parts 17A, 17B on both lateral sides for abutment with side edges 14A, 14B formed on both lateral sides at the end of the tongue portion 11. The height of the radial step formed by stepped parts 17A, 17B corresponds to the thickness of the flat band material 1. Therefore, the closed clamp 10 in its closed state provides a substantially stepless inner surface facing the object to be fastened.

Going from the tongue portion 11 circumferentially in the direction towards the second end portion 3 of the band 1, the clamp 10 has a preassembling hook 12 adapted to be received in an aperture 42 of the second tensioning hook 40 in the preassembled state (see FIG. 4).

Circumferentially next to the preassembling hook 12 is the combined arrangement of the connecting or load retaining hook 20 and the first tensioning hook 30. The connecting hook 20 and the first tensioning hook 30 are directly contacting each other in the circumferential direction at a curved contact line 28. While the connecting hook 20 and the first tensioning hook 30 both protrude radially from the level of the undeformed band material 1, the contact line 28 is at the same level as the undeformed band material 1. The connecting hook 20 has a central cut-out window 22 which will be described in greater detail below with respect to FIGS. 5A and 5B.

The connecting hook 20 has a free edge portion 21 forming the radially outermost tip end of the hook 20 and serving as an engagement tooth which is adapted to be received in the aperture 42 of the second tensioning hook 40 (see FIG. 4) in a closed state of the clamp 10. The edge portion 21 points in the circumferential direction towards the second end portion 3 so that it hooks into the aperture 42 when the two end portions 2 and 3 are pulled circumferentially away from each other in the closed state of the clamp 1. The connecting hook 20 further has, in the circumferential direction opposite to the window 22, a back surface which has a smooth radial slope and provides a ramp for the outermost end of the second end portion 3 during the closing operation of the clamp 10.

The first and second tensioning hooks 30, 40 are both provided with tooth-like projections 31, 41 facing towards each other in the circumferential direction. These tooth-like projections 31, 41 allow for forming an anti-slip form fit with the jaws of pliers (not shown) engaging with the first and second tensioning hooks 30, 40 in a closing operation of the clamp 10.

Side rails 13A, 13B are formed as additional stiffening ribs at the left and right lateral side of at least that part of the first end portion 2 where the connecting hook 20 and the first tensioning hook 30 are formed. The side rails 13A, 13B are formed to extend generally in the longitudinal (=circumferential) direction of the band material 1 and extend preferably up to the region where the tongue portion 11 is formed. This is to avoid kinking of the tongue portion 11 during the clamp closure.

The side rails 13A, 13B protrude radially inwards, i.e., in the radial direction which is opposite to the radial direction into which the connecting hook 20 and the first tensioning hook 30 protrude. Thereby, the side rails 13A, 13B not only improve the mechanical stability of the clamp against buckling or bending in the region of the connecting hook 20. The fact that the side rails 13A, 13B project radially inwards also guarantees firm and uniform radial compression of the clamp 10 against the object to be fastened along the complete inner circumference including the critical portion where the tensioning and connecting hooks 20, 30, 40 are formed.

The clamp 10 is further provided with plural tolerance compensating waves 18 at the second end portion 3. The curved radial shape of the tolerance compensating waves 18 allows for compensation of certain diameter variations in the clamp 10 and the object to be fastened. The tolerance compensating waves 18 also have a curvature in the axial direction which allows for having at least a portion of the tolerance compensating waves 18 to fit tightly on the object to be fastened even when other portions of the tolerance compensating waves 18 remain at a radial distance from the object to be fastened.

Now the manufacturing process of the tensioning hook 20 of the first embodiment will be described in greater detail resorting to FIGS. 5A and 5B. FIG. 5A shows a part of the flat metal band material 1 in which the window 22 has been cut away. The window 22 is generally U-shaped and composed of a base portion 23 having the shape of a rounded rectangle and two rounded portions 24 positioned at two laterally opposing corners of the base portion 23. Each of the two rounded portions 24 is arc-shaped and forms a semi-circle so that a free edge portion 21 is formed therebetween.

After cutting out the window 22 shown in FIG. 5A, the band material 1 is deformed or embossed to raise the free edge portion 21 and a complete rim of the window 22 radially outwards. This leads to the final collar-like configuration of the connecting hook 20 shown in FIG. 5B. Due to the rounded shape and the overall extension of the cut-out window 22 as a two-dimensional area, the cutting and embossing steps in the clamp manufacturing process have a lower tendency to produce cracks as compared to conventional clamp manufacturing. Also, the shape of the connecting hook 20 with the window rim raised as a collar in the radial direction helps to distribute any deformation stress acting on the hook 20 evenly in three dimensions, i.e., not only in the axial and radial directions but also in the circumferential direction.

FEA studies have further shown that the two rounded portions 24 and the raised outer rim of the window 22 provide the connecting hook 20 with optimised distribution characteristics of load and mechanical stress. Thereby, it has enhanced rigidity and strength against radial forces, stress and shocks which may act on the free edge portion 21 during use of the clamp in the closed configuration. In particular, cracks at the lateral side portions next to the edge portion 21 are much less likely to occur due to the fact that portions 24 have no sharp edges but have a rounded, preferably semi-circular, shape.

Instead of or in addition to the connecting hook 20 as described in the first embodiment, it may also be one or both of the first and second tensioning hooks 30, 40 that is strengthened by a cut-out window. This is shown as a second embodiment in present FIG. 6 for the second tensioning hook 40.

Starting from the same window shape with the base portion 23 and the two rounded portions 24 shown in FIG. 5A, one may obtain the hook design with the cut-out window 43 and the tooth-like projection 41 shown in FIG. 6. An additional cutting of the band material in the width direction of the band (not shown in FIG. 5A) is needed to form the aperture 42. Use of the same window shape as for the connecting hook 20 shown in FIG. 5B provides the advantage that the same cutting/punching tool may be used for both windows 22, 43. However, different shapes which are optimised for the shape of the individual connecting and/or tensioning hook may be used and fall within the scope of the present invention. Moreover, instead of or in addition to the connecting hook 20 and the second tensioning hook 40, it may also be the first tensioning hook 30 that is provided with a cut-out window in the region adjacent to the tooth-like projections 31 even though this is not shown in the drawings and the detailed embodiments.

As shown in FIG. 6, three of the four sides of the cut-out window frame are raised radially outwards. Only the side which is opposite to the tooth projection 41 remains in the plane of the unraised band material. In other words, the sides or rim portions of the window 43 which are closest to the band's axial side edges are raised in addition to the side where the tooth projection 41 is formed as a radial peak. Thereby, the second tensioning hook 40 is formed to have the shape of a canopy or shell with arc-like side portions adjacent to the tooth projection 41. These arc-like side portions allow to distribute deformation stress acting on the window rim not only radially and axially along the extension of the band material but also radially and circumferentially along the extension of the band material. Thereby, the window 43 becomes more resistant against exterior stress forces and the load retaining characteristics of the second tensioning hook 40 improve.

The present invention also covers, as an alternative which is independent from any specific shape of the connecting hook 20 and the first and second tensioning hooks 30, 40, the curved contact portion 28 between the connecting hook 20 and the first tensioning hook 30 as the main characterising feature. In particular, the present invention is also directed to:
[1] A clamp (10) made of a clamping band (1) having first and second circumferential end portions (2, 3) which overlap one another in a closed condition of the clamp (10), the clamp (10) comprising
   a connecting hook (20) protruding radially outwards at the first end portion (2),
   a first tensioning hook (30) protruding radially outwards at the first end portion (2), and
   a second tensioning hook (40) protruding radially outwards at the second end portion (3) and having an aperture (42) for receiving an edge portion (21) of the connecting hook (20) in the closed condition of the clamp (10),
   wherein the connecting hook (20) and the first tensioning hook (30) are positioned circumferentially adjacent to each other on the first end portion (2),
   characterised in that a contact region (28) between the connecting hook (20) and the first tensioning hook (30) has a curved shape, preferably a curved line shape.
[2] The clamp (10) of [1], wherein the contact region (28) does not protrude radially from the level of the flat clamping band (1).
[3] The clamp (10) of [1] or [2], wherein at least one of the connecting hook (20) and the first and second tensioning hooks (30, 40) has a cut-out window (22, 43) in which a two-dimensional area of material is removed from the clamping band (1).
[4] The clamp (10) of [3], wherein the window (22, 43) has rounded portions (24) in regions laterally adjacent to the edge portion (21) and/or the tooth-like projection (31, 41) of the first or second tensioning hook (30, 40).
[5] The clamp (10) of [4], wherein the rounded portions (24) have semi-circular shape.
[6] The clamp (10) of [4] or [5], wherein the window (22, 43) has a base portion (23) in a region circumferentially adjacent to the edge portion (21) and/or the tooth-like projection (31, 41) of the first or second tensioning hook (30, 40) in the direction towards the other end portion (3, 2).
[7] The clamp (10) of [6], wherein the base portion (23) has the shape of a rectangle with rounded corners.
[8] The clamp (10) of any of [4] to [7], wherein the window (22, 43) surrounds the edge portion (21) of the connecting hook (20) and/or the tooth-like projection (31, 41) of the first or second tensioning hook (30, 40) from both lateral sides in the width direction and from one side in the circumferential direction of the clamping band (1).
[9] The clamp (10) of any of [1] to [8], further comprising
   radially protruding side rails (13A, 13B) formed on the first end portion (2) at both lateral sides of the band region in which the connecting hook (20) and the first tensioning hook (30) are formed, and/or
   a tongue portion (11) formed at the circumferential end of the first end portion (2) and configured to be inserted into a tongue channel (19) formed at the second end portion (3), and/or
   at least one radially outward projecting tolerance compensating wave (18) preferably formed at the second end portion (3) and optionally curved in the axial direction.

List of Reference Signs

| | |
|---|---|
| 1 | flat band material |
| 2 | first end |
| 3 | second end |
| 10 | clamp |
| 11 | tongue portion |
| 12 | preassembling hook |
| 13A, 13B | side rails |
| 14A, 14B | side edges |
| 17A, 17B | stepped part |
| 18 | tolerance compensation waves |
| 19 | tongue channel |
| 20 | connecting hook |
| 21 | protruding edge portion |
| 22 | cut-out window (U-shaped) |
| 23 | base portion (rounded rectangle) |
| 24 | tip portions (semi-circular) |
| 28 | contact region (curved line) |
| 30 | first tensioning hook |
| 31 | tooth projections |
| 40 | second tensioning hook |
| 41 | tooth projection |
| 42 | aperture |
| 43 | cut-out window |

1. A clamp (10) made of a clamping band (1) having first and second circumferential end portions (2, 3) which overlap one another in a closed condition of the clamp (10), the clamp (10) comprising:
a connecting hook (20) protruding radially outwards at a first end portion (2);
a first tensioning hook (30) protruding radially outwards at the first end portion (2); and
a second tensioning hook (40) protruding radially outwards at the second circumferential end portion (3) and having an aperture (42) for receiving an edge portion (21) of the connecting hook (20) in the closed condition of the clamp (10),
wherein at least one of the connecting hook (20) and the first and second tensioning hooks (30, 40) has a cut-out window (22, 43) in which a two-dimensional area of material is removed from the clamping band (1).

2. The clamp (10) of claim 1, wherein at least parts of the rim of the cut-out window (22, 43) comprising at least 50% of the entire window rim are raised radially outwards.

3. The clamp (10) of claim 2, wherein all of the window rim except from the portions of the window (43) which are opposite to a tooth-like projection (41) of the second tensioning hook (40) are raised radially outwards to form a shell-shaped protrusion with a peak formed by the tooth-like projection (41) of the second tensioning hook (40).

4. The clamp (10) of claim 2, wherein the entire rim of the cut-out window (22) is raised radially outwards to form a collar-like protrusion with a peak formed by the edge portion (21) of the connecting hook (20).

5. The clamp (10) of claim 1, wherein the window (22, 43) has rounded portions (24) in regions laterally adjacent to the edge portion (21) and/or a tooth-like projection (31, 41) of the first or second tensioning hook (30, 40).

6. The clamp (10) of claim 5, wherein the rounded portions (24) have a semi-circular shape.

7. The clamp (10) of claim 5, wherein the window (22, 43) has a base portion (23) in a region circumferentially adjacent to the edge portion (21) and/or the tooth-like projection (31, 41) of the first or second tensioning hook (30, 40) in the direction towards the other end portion (3, 2).

8. The clamp (10) of claim 7, wherein the base portion (23) has a shape of a rectangle with rounded corners.

9. The clamp (10) of claim 5, wherein the window (22, 43) surrounds the edge portion (21) of the connecting hook (20) and the tooth-like projection (31, 41) of the first or second tensioning hook (30, 40) from both lateral sides in the width direction and from one side in the circumferential direction of the clamping band (1).

10. The clamp (10) of claim 1, wherein
the connecting hook (20) and the first tensioning hook (30) are positioned circumferentially adjacent to each other on the first end portion (2), and
a contact region (28) between the connecting hook (20) and the first tensioning hook (30) has a curved shape, preferably a curved line shape.

11. The clamp (10) of claim 10, wherein the contact region (28) does not protrude radially from the level of the flat clamping band (1).

12. The clamp (10) of claim 1, further comprising radially protruding side rails (13A, 13B) formed on the first end portion (2) at both lateral sides of the band region in which the connecting hook (20) and the first tensioning hook (30) are formed.

13. The clamp (10) of claim 1, further comprising a tongue portion (11) formed at the circumferential end of the first end portion (2) and configured to be inserted into a tongue channel (19) formed at the second end portion (3).

14. The clamp (10) of claim 1, further comprising
at least one radially outward protruding tolerance compensating wave (18) preferably formed at the second end portion (3) and optionally curved in the axial direction.

15. A method of forming a clamp (10) from a flat clamping band (1) having first and second circumferential end portions (2, 3) which are configured to overlap one another in a closed condition of the clamp (10), the method comprising:
removing a two-dimensional area of material from the clamping band (1) to form a cut-out window (22, 43);
forming the clamping band (1) to provide a connecting hook (20) protruding radially outwards at the first end portion (2);
forming the clamping band (1) to provide a first tensioning hook (30) protruding radially outwards at the first end portion (2); and
forming the clamping band (1) to provide a second tensioning hook (40) protruding radially outwards at the second end portion (3) and having an aperture (42) for receiving an edge portion (21) of the connecting hook (20) in the closed condition of the clamp (10),
wherein at least one of the connecting hook (20) and the first and second tensioning hooks (30, 40) is formed in a region surrounding the cut-out window (22, 43).
